(19) United States
(12) Patent Application Publication
(10) Pub. No.: US 2010/0088638 A1
(43) Pub. Date: Apr. 8, 2010

(54) GEOGRAPHIC INFORMATION SYSTEM AND METHOD OF USE THEREOF

(75) Inventors: Judith S. Miller, Holland, OH (US); Christopher J. Miller, Holland, OH (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: NINTH WAVE MEDIA, LLC, Toledo, OH (US)

(21) Appl. No.: 12/572,573

(22) Filed: Oct. 2, 2009

Related U.S. Application Data
(60) Provisional application No. 61/102,605, filed on Oct. 3, 2008.

(51) Int. Cl. G06F 3/048

(52) U.S. Cl. 715/823

(57) ABSTRACT

A geographic information system includes a server having a geographical user interface for communicating over a computer network, a database having location-specific information, and a website in communication with the database for accessing location-specific information. The geographic information system further includes a web page configured to display location-specific information, wherein the web page includes a plurality of icons, one of which illuminates automatically upon input of a selected location and provides a link to selected location-specific information.

### CROSS-REFERENCE TO RELATED APPLICATIONS

This application claims the benefit of U.S. Provisional Application No. 61/102,605, filed Oct. 3, 2008, the disclosure of which is incorporated herein by reference.

### BACKGROUND OF THE INVENTION

This invention relates in general to a geographic information system that integrates hardware, software, and data for capturing, managing, analyzing, and displaying all forms of geographically referenced information. In particular, this invention relates to an improved geographic information system that includes one or more internet websites and web pages on the internet that are capable of identifying and displaying geographic location-specific information to a user.

A geographic information system is a system that integrates hardware, software, and data for capturing, managing, analyzing, and displaying all forms of geographically referenced information. Typically, a geographic information system is associated with a map. Geographic information systems can be used in a variety of ways to view, understand, question, interpret, and visualize data in many ways that reveal relationships, patterns, and trends.

The internet is an effective channel through which government officials and others can reach millions of Americans with important information on a plethora of issues relevant to daily life. For example, according to a December 2006 survey from the Pew Internet & American Life Project, 70 percent of adults now use the internet, with the largest usage by adults 18-29 (83 percent), followed by adults ages 30-49 (82 percent), adults ages 50-64 (70 percent), and adults age 65 and over (33 percent). Most significant, of those adults who use the internet, 66 percent reported that they visited a local, state, or federal government website in an August 2006 Pew survey. Furthermore, an April 2009 survey by the Pew Research Center's Internet & American Life Project shows 63% of adult Americans now have broadband internet connections at home, a 15% increase from a year earlier. April's level of high-speed adoption represents a significant jump from figures gathered by the Project since the end of 2007 (54%).

To date, when important public safety information has been distributed online as a passive, one-way stream of information flowing from government and other sources to the public. While the value of such information is undisputed, the tremendous advances in both hardware and software design now provide citizens with the impetus to take ownership of emergency preparedness and mitigation through a Web 2.0 system to lessen the strain on the 911 system so that first responders can focus on the most critical needs of government and the citizenry. Thus, it would be desirable to have a geographic information system or a public emergency portal system and method of identifying geographic information so that actionable information can be delivered to the public for general daily use and for emergency mitigation. With a selected location, citizens will know what to do, where to go, and how they can help their fellow neighbors to actively participate in emergency mitigation in their local communities. These objectives and others are met by the present invention.

### SUMMARY OF THE INVENTION

In a first aspect, there is provided herein a geographic information system. The geographic information system includes a server having a graphical user interface for communicating over a computer network and a database having location-specific information. The geographic information system further includes a website in communication with the database for accessing location-specific information and a web page configured to display location-specific information, wherein the web page includes a plurality of icons which may be color-coded and have distinct shapes, one of which illuminates automatically upon input of a selected location, such as a zip code, and provides a link to selected location-specific information. In certain embodiments, the location-specific information is within a zip code boundary or within a pre-determined distance from a point within the zip code boundary.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic view of a geographic information system in accordance with this invention.

FIG. 2 is an exemplary flow diagram showing the manner of operation of the geographic information system illustrated in FIG. 1.

FIG. 3 is a view of an exemplary web page for the geographic information system illustrated in FIG. 1.

FIG. 4 is an updated view of the web page illustrated in FIG. 3 showing a first illuminated icon generated in response to the input of a first selected location.

FIG. 5 is an exemplary web page of a response of the geographic information system displaying location-specific information within the first selected location.

FIG. 6 is an updated view of the web page illustrated in FIG. 3 showing a second illuminated icon generated in response to the input of a second selected location.

FIG. 7 is an exemplary web page of a response of the geographic information system displaying location-specific information within the second selected location.

FIG. 8 is an updated view of the web page illustrated in FIG. 3 showing a third illuminated icon generated in response to the input of a third selected location.

FIG. 9 is an exemplary web page of a response of the geographic information system displaying location-specific information within the third selected location.

### DETAILED DESCRIPTION OF THE PREFERRED EMBODIMENT

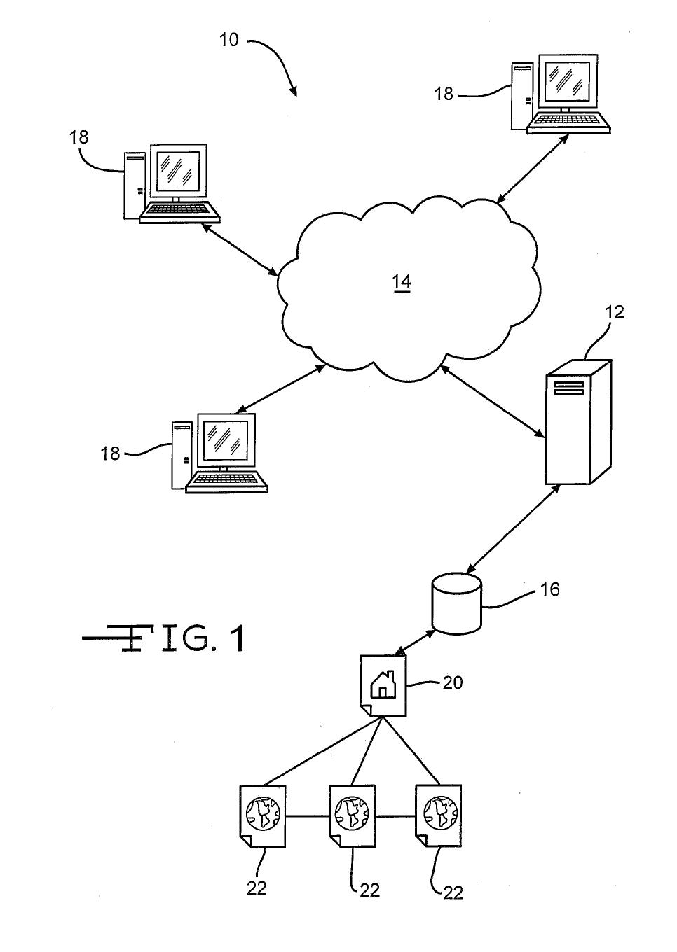

Referring to FIG. 1, there is illustrated a geographic information system, indicated generally at 10, in accordance with this invention. The illustrated geographic information system 10 includes a server 12 having a graphical user interface for communicating over a computer network 14, such as the internet. In accordance with exemplary embodiments, the computer network 14 can be an IP-based network that transmits data in the form of geographic location-specific information from a database 16 to a plurality of users 18. For example, the computer network 14 can be a conventional managed IP network administered by a service provider. The database 16 includes location-specific information for a website 20 having one or more navigable web pages 22. The web pages 22 are configured to display the geographic location-specific information.

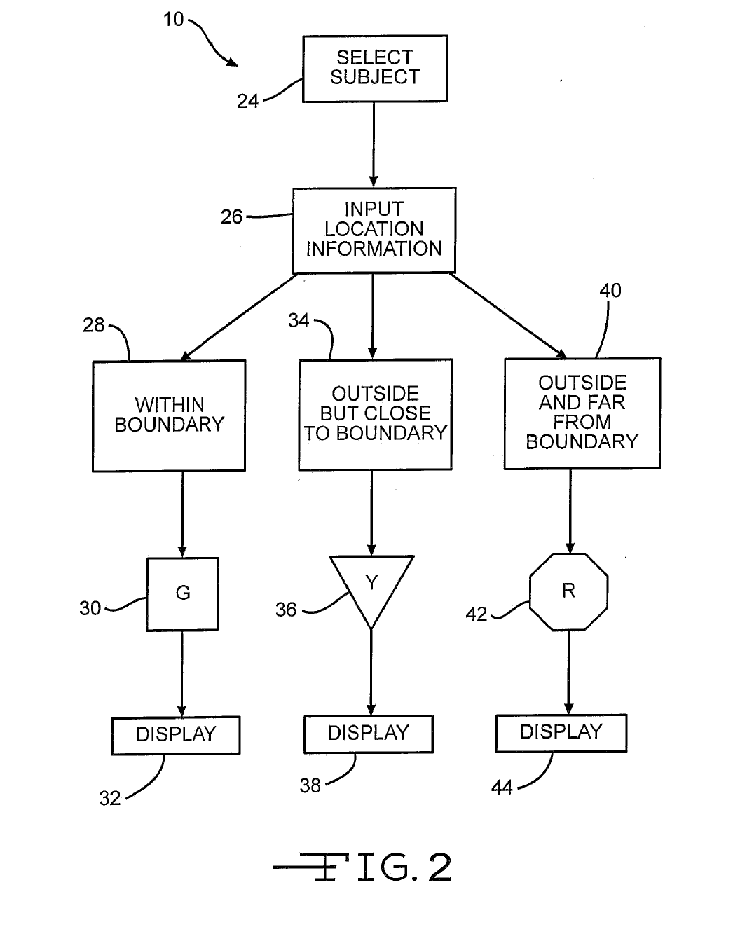

FIG. 2 is an exemplary flow diagram illustrating the operation of the geographic information system 10. In accordance with the exemplary flow diagram, a user first selects a subject from a list of desired actionable items 24 (e.g., seasonal flu shots, pharmacy, 24-hour pharmacies, and drive-thru pharmacies) and inputs selected geographic location information (e.g., zip code) 26 on a web page 22 (FIG. 1) to access geographic location-specific information relevant to the desired actionable item. If the geographic location-specific information is within a boundary 28 of the selected geographic location information 26, a first icon 30 (such as a green square icon) illuminates on the web page 22 and serves as a link to another web page showing a display 32 of geographic location-specific information. If the geographic location-specific information is outside, but within a predetermined distance, of the boundary 34 of the selected geographic location information 26, a second icon 36 (such as a yellow triangle icon) illuminates on the web page 22 and serves as a link to a web page showing a display 38 of geographic location-specific information. If the geographic location-specific information is outside of, and outside of a predetermined distance from, the boundary 40 of the selected location information 26, a third icon 42 (such as a red octagon) illuminates on the web page 22 (FIG. 1) and serves as a link to a web page showing a display 44 of geographic location-specific information.

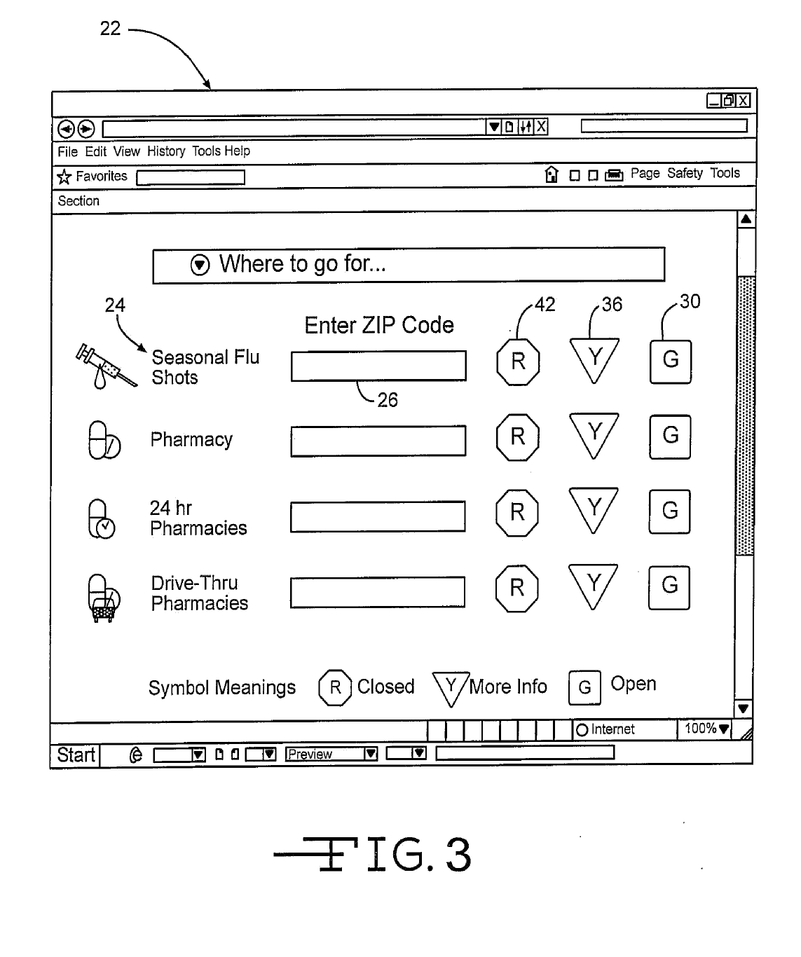

FIG. 3 is an exemplary web page 22 of the geographic information system 10. As shown in FIG. 3, the geographic location-specific information can relate to various actionable items 24, such as seasonal vaccines (e.g., flu shots, etc.), pharmacies, 24-hour pharmacies, and drive-thru pharmacies. A user may access the geographic location-specific information for any of the actionable items 24 via website 20 as desired or in response to an event, such as a public emergency. Corresponding to each actionable item 24 is a blank area for entering a selected geographic location 26, such as a zip code. Alternatively, other geographic location identifiers may be used, such as addresses, building names, street intersections, cities, counties, and the like.

Web page 22 includes a plurality of icons 30, 36, 42 corresponding to each actionable item 24. In response to the input of the selected geographic location 26, one of the plurality of icons will illuminate automatically and automatically provide a link to selected geographic location-specific information. The plurality of icons include a first icon 30 that can be illuminated as a green square, a second icon 36 that can be illuminated as a yellow triangle, and a third icon 42 that can be illuminated as a red octagon, in response to a user's selected location 26. The first icon 30 can be configured as a green square to symbolize a go traffic light, the second icon 36 can be configured as a triangle to symbolize a yield sign, and the third icon 42 can be configured as an octagon to symbolize a stop sign. The G icon 30 can indicate that geographic location-specific information is available to identify facilities that are open and/or available within the boundary of the specified location. The Y icon 36 can indicate that geographic location-specific information is available to identify facilities that are open and/or available not within the boundary of the specified location, but within a predetermined distance from the boundary of the specified location. The R icon 42 can indicate that geographic location-specific information is not available to identify facilities that are open and/or available, either within the boundary of the specified location or within a predetermined distance from the boundary of the specified location. It is contemplated that the term open can simply mean available (e.g., ATM, mailbox, etc.).

It has been found that the specific representations of the first, second, and third icons 30, 36, and 42 described above have been found to demonstrate advantageous utility in facilitating the use of the geographic information system of this invention. Specifically, these icons 30, 36, and 42 are designed to support visually impaired users and, as such, represent an integration of an accessibility feature within the functionality of the icons. However, it is also contemplated that the first, second, and third icons 30, 36, and 42 may alternatively be embodied having other desired representations, such as circles, rectangles, triangles, and the like, which may symbolize traffic lights or other graphic items.

Geographic location-specific information can be within a zip code boundary, within a predetermined distance (e.g., 2.5 miles) of the zip code boundary, or outside of a zip code boundary and outside of a predetermined distance (e.g., 2.5 miles) of the zip code boundary. In a preferred embodiment, the selected location is an area that is designated by a zip code. Alternatively, the selected location may be only a specific point that is located within the zip code area, such as at the approximate geographic center of the zip code area for example, with the boundary being a predetermined distance from that point.

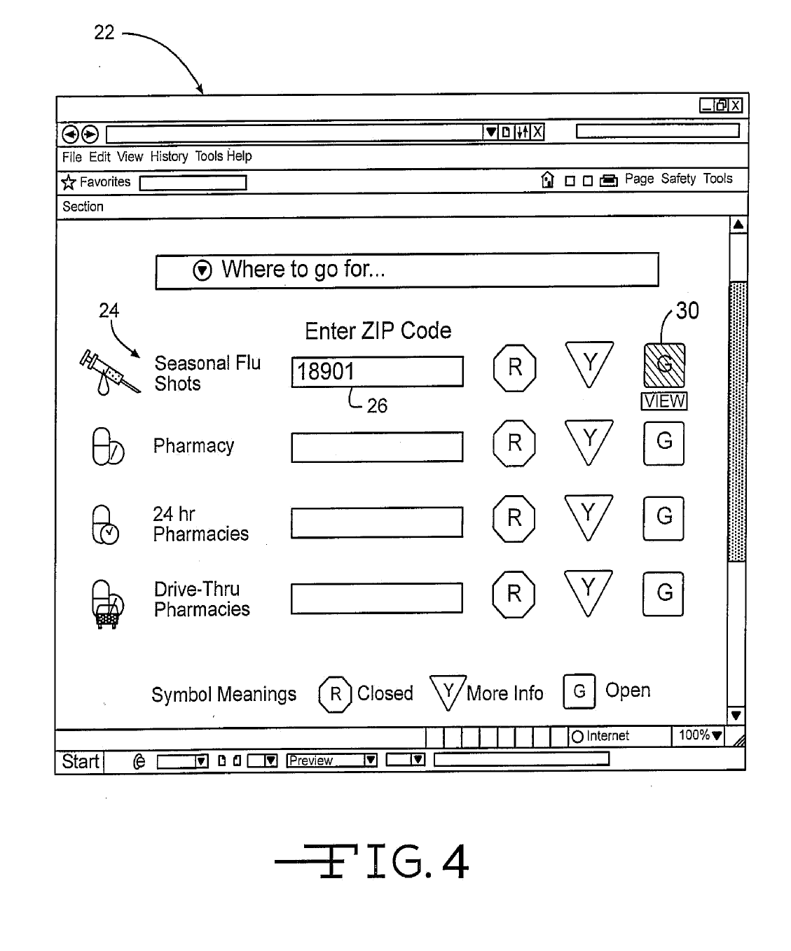

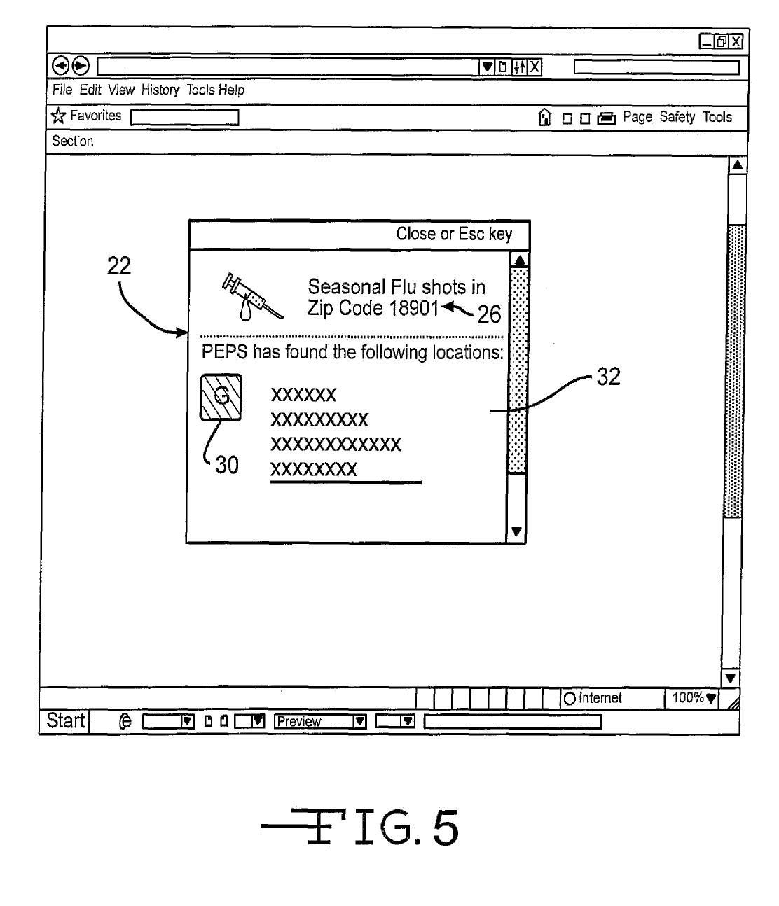

FIG. 4 is an exemplary web page 22 of the geographic information system 10 illustrating the G icon 30 illuminated in green in response to entry of a selected geographic location 26. In an exemplary embodiment, the selected geographic location 26 is a zip code. The geographic location-specific information can be accessed by selecting the illuminated G icon 30. FIG. 5 is an exemplary web page 22 of the geographic information system 10 displaying geographic location-specific information 32 within a zip code boundary of a selected geographic location 26.

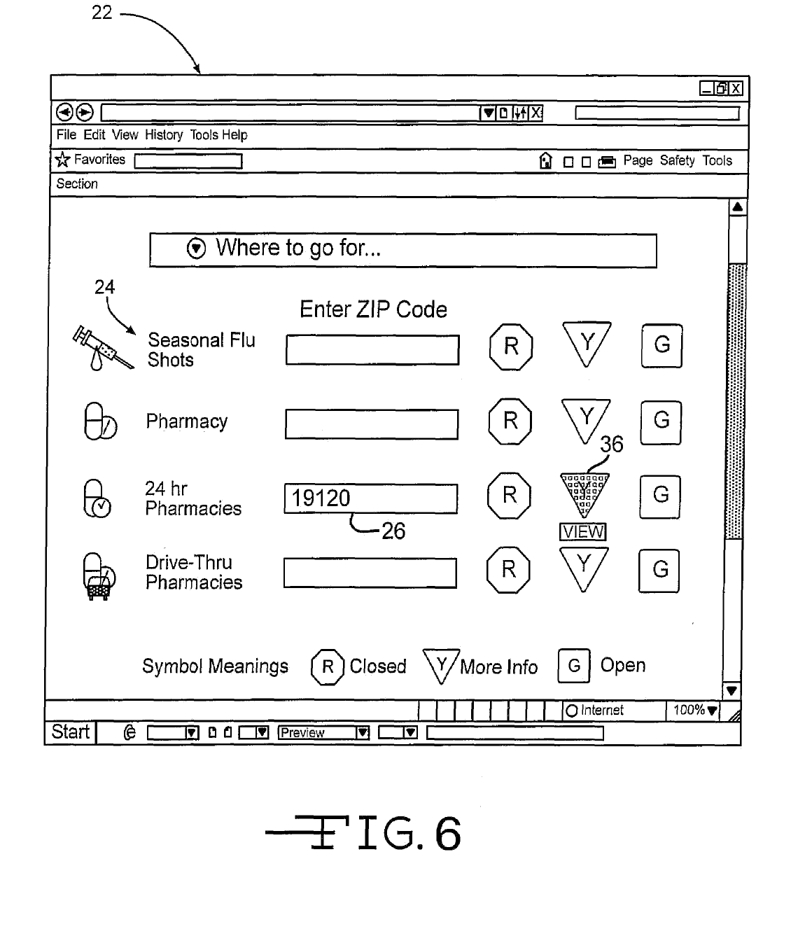

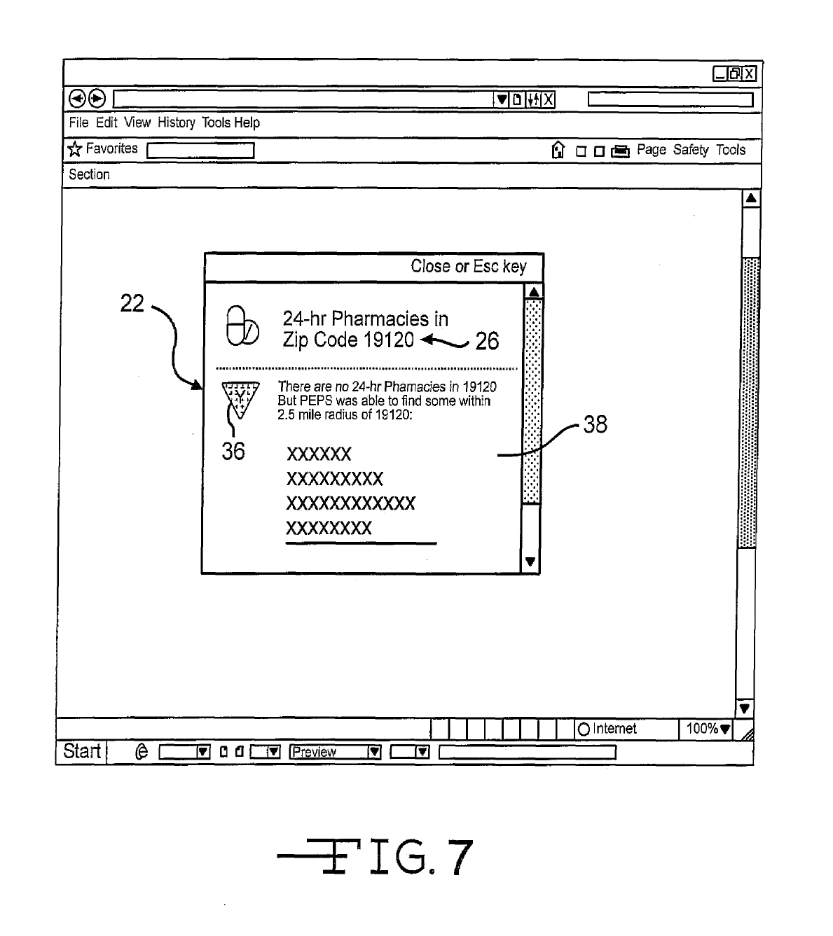

FIG. 6 is an exemplary web page 22 of the geographic information system 10 illustrating the Y icon 36 illuminated in yellow in response to entry of a selected geographic location 26. In an exemplary embodiment, the selected geographic location 26 is a zip code. The geographic location-specific information can be accessed by selecting the illuminated Y icon 36. FIG. 7 is an exemplary web page 22 of the geographic information system 10 displaying geographic location-specific information 38 within a predetermined distance (e.g., 2.5 miles) of a selected geographic location 26.

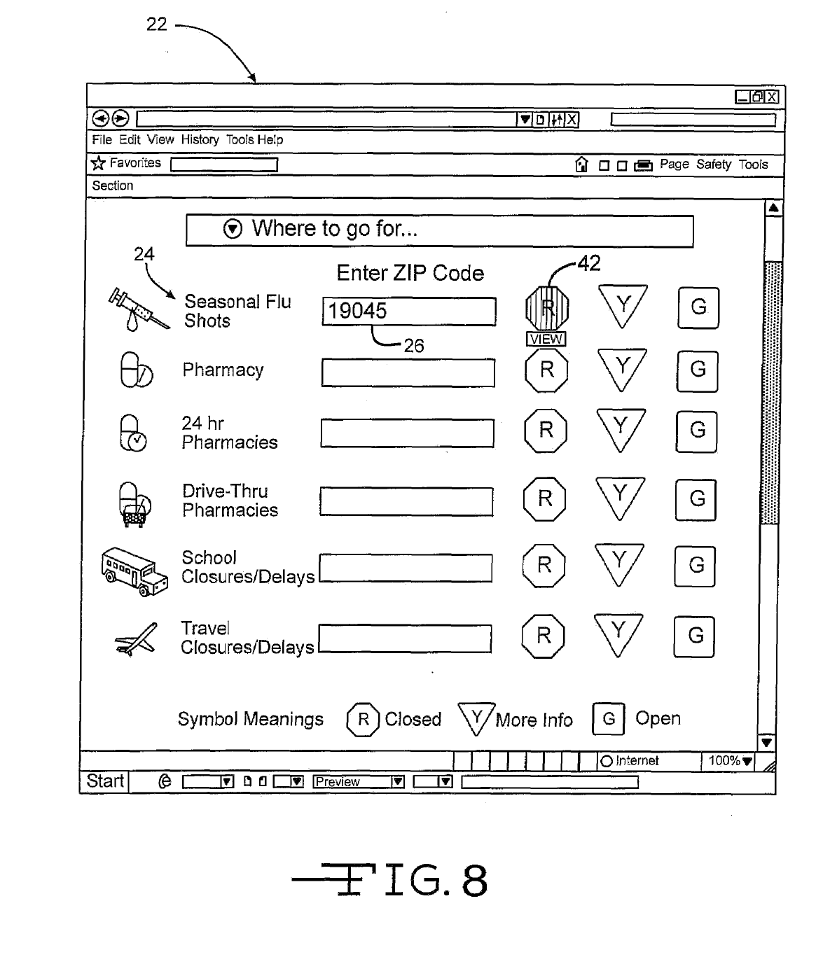

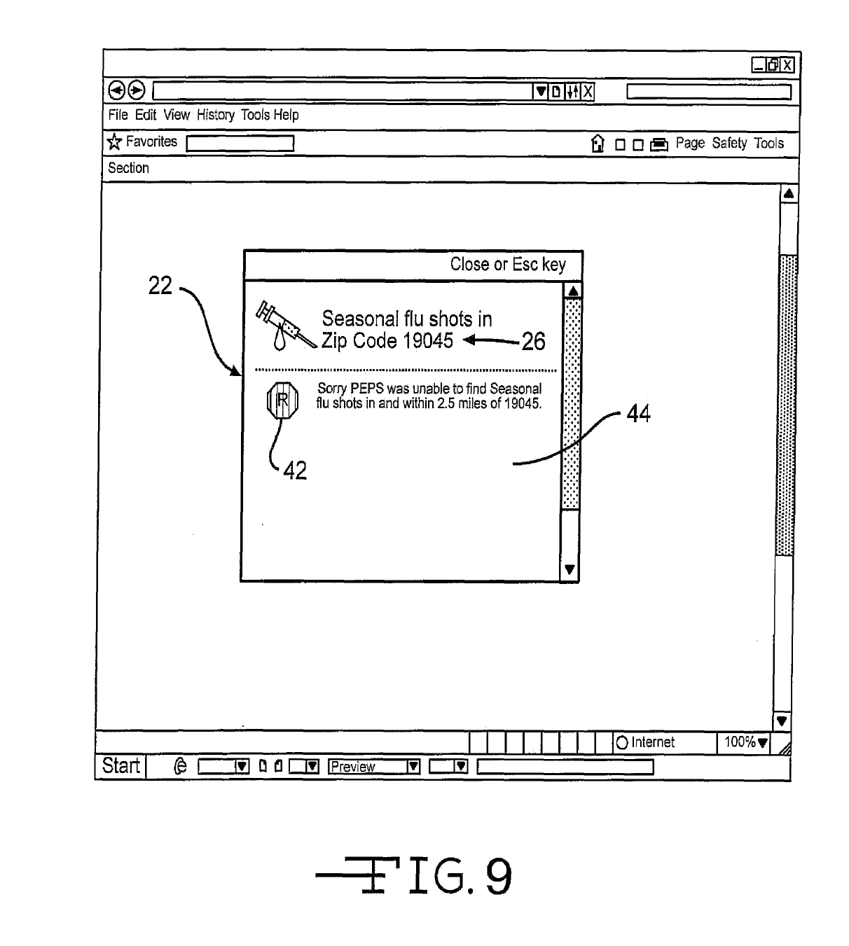

FIG. 8 is an exemplary web page 22 of the geographic information system 10 illustrating the R icon 42 illuminated in red in response to entry of a selected geographic location 26. In an exemplary embodiment, the selected geographic location 26 is a zip code. FIG. 9 is an exemplary web page 22 of the geographic information system 10 displaying geographic location-specific information 44 outside of a zip code boundary (or outside of a first predetermined distance from a point within the boundary) and outside of a predetermined distance (e.g., 2.5 miles) of a selected geographic location 26. If the database 16 does not include any geographic location-specific information for a selected actionable item 24 within, near, or outside of the selected geographic location 26, the web page 22 will indicate that no information is available. It is contemplated that the geographic information system 10 can be configured to display geographic location-specific information 44 outside of the boundary associated with a selected geographic location 26.

In a further exemplary embodiment, geographic location-specific information can relate to various actionable items 24, such as seasonal vaccines (e.g., flu shots), pharmacies, 24-hour pharmacies, drive-thru pharmacies, school closures, school delays, travel closures, and travel delays. The geographic location-specific information can be accessed by selecting the illuminated R icon 42.

In another exemplary embodiment, geographic location-specific information can be building-specific information or office-specific information. The selected geographic location can be based on a user's IP address and wireless logins.

It is to be understood that the geographic information system of the present invention can be specifically customized for either community use (e.g., general daily use) or emergency use (e.g., emergency mitigation or response to a public emergency).

It is to be further understood that the geographic information system of the present invention can have a customized display on the website such that other pertinent community or emergency information may be displayed in addition to the information shown in the exemplary embodiments, FIGS. 3, 4, 6, and 8.

The geographic information system of the present invention provides geographic location-specific, actionable information to the public to encourage public ownership of mitigation during natural disasters and other public emergencies thus reducing strain, and subsequent costs, on city and county emergency response agencies. It is contemplated that the geographic information system provides city, state, and federal officials with the capability of speaking directly to the public through live video alerts that can be accessed 24/7 by users on all portal pages within the public emergency portal solution and provides the public with an organized, meaningful way to volunteer during emergencies by matching citizens in need with volunteers through portal features, such as neighborhood blogs. It is further contemplated that the geographic information system can act as a county's central clearinghouse and destination website during emergencies with links to existing city, state, and federal information, and provide an optional, secure section for first responders as an interim interoperability solution. The geographic information system provides a web-based format and optimal functionality to reduce panic and rumors during emergencies, and provides capability to send text messages to cell phones in times of emergency to maximize dissemination of accurate information.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A geographic information system comprising:
a server having a graphical user interface for communicating over a computer network;
a database having location-specific information;
a website in communication with the database for accessing location-specific information;
a web page configured to display location-specific information;
wherein the web page includes a plurality of icons, one of which illuminates automatically upon input of a selected location and provides a link to selected location-specific information.

2. The geographic information system defined in claim 1 wherein the location-specific information is accessed by selecting the illuminated icon.

3. The geographic information system defined in claim 1 wherein the selected location is a zip code.

4. The geographic information system defined in claim 3 wherein the location-specific information is within the zip code boundary.

5. The geographic information system defined in claim 3 wherein the location-specific information is within a predetermined distance from a point within the zip code boundary.

6. The geographic information system defined in claim 3 wherein the location-specific information is outside of the zip code boundary and outside of a predetermined distance from a point within the zip code boundary.

7. The geographic information system defined in claim 1 wherein the plurality of icons comprise a first icon that can be illuminated in red, a second icon that can be illuminated in yellow, and a third icon that can be illuminated in green, in response to the selected location.

8. The geographic information system defined in claim 7 wherein the first icon is configured as an octagon and labeled R, the second icon is configured as an inverted triangle and labeled Y, and the third icon is configured as a square and labeled G.

9. The geographic information system defined in claim 7 wherein: location-specific information within a first predetermined distance of a point within a zip code is displayed when the third icon is illuminated in response to a selected location; location-specific information within a second predetermined distance of the point within the zip code is displayed when the second icon is illuminated in response to a selected location; and location-specific information outside of the second predetermined distance from the point within the zip code is displayed when the first icon is illuminated in response to a selected location.

10. The geographic information system defined in claim 1 wherein the location-specific information relates to at least one of seasonal vaccines, pharmacies, 24-hour pharmacies, drive-thru pharmacies, school closures, school delays, travel closures, and travel delays.

11. The geographic information system defined in claim 10 wherein the seasonal vaccines include flu shots.

12. The geographic information system defined in claim 1 wherein the location-specific information may be accessed via the website in response to an event comprising a public emergency.

13. A method of identifying geographic information comprising the steps of:
(a) providing a server having a graphical user interface for communicating over a computer network;
(b) providing a database having data related to location-specific information;
(c) providing a website in communication with the database for accessing location-specific information;
(d) providing a web page configured to display location-specific information, wherein the web page includes a plurality of icons;
(e) inputting a selected location into the web page to illuminate automatically one of the plurality of icons; and
(f) selecting the illuminated icon to access the selected location-specific information.

14. The method of claim 13 wherein the selected location is a zip code and the location-specific information is within the zip code boundary or within a predetermined distance of a point within the zip code boundary.

15. The method of claim 14 wherein the location-specific information is outside of the zip code boundary and outside of a predetermined distance from a point within the zip code boundary.

16. The method of claim 13 wherein the plurality of icons comprise a first icon that can be illuminated in red, a second icon that can be illuminated in yellow, and a third icon that can be illuminated in green, in response to the selected location.

17. The method of claim 16 wherein the first icon is configured as an octagon and labeled R, the second icon is configured as an inverted triangle and labeled Y, and the third icon is configured as a square and labeled G.

18. The method of claim 16 wherein: location-specific information within a zip-code boundary is displayed when the third icon is illuminated in response to a selected location; location-specific information within a predetermined distance of a zip-code boundary is displayed when the second icon is illuminated in response to a selected location; and location-specific information outside of a zip-code boundary and outside of a predetermined distance of the zip-code boundary is displayed when the first icon is illuminated in response to a selected location.

19. The method of claim 13 further comprising accessing the location-specific information via the website for seasonal vaccines, pharmacies, 24-hour pharmacies, drive-thru pharmacies, school closures, school delays, travel closures, and travel delays.

20. The method of claim 13 further comprising accessing the location-specific information via the website in response to an event comprising a public emergency.
